(19) United States
(12) Patent Application Publication
(10) Pub. No.: US 2026/0216917 A1
(43) Pub. Date: Jul. 30, 2026

(54) SYSTEM AND METHOD OF APPLYING A LUBRICANT ON AN AIRFOIL CONNECTOR

(71) Applicant: TECHJET AEROFOILS LTD, Migdal Tefen (IL)

(72) Inventor: Idan BIRMAN, Naharia (IL)

(73) Assignee: TECHJET AEROFOILS LTD, (omitted)

(21) Appl. No.: 19/039,797

(22) Filed: Jan. 29, 2025

(51) Int. Cl. B28B 17/00; B28B 1/00; B33Y 10/00; B33Y 30/00; B33Y 50/02

(52) U.S. Cl. CPC B28B 17/0081; B28B 1/001; B33Y 10/00; B33Y 30/00; B33Y 50/02

(57) ABSTRACT

Systems and methods for applying graphite on an airfoil connector, the method comprising: receiving, by a processor, a three-dimensional (3D) surface area plan for the airfoil connector; imaging the airfoil connector to determine a 3D scheme of the airfoil connector; comparing, by the processor, the received 3D surface area plan and the determined 3D scheme to determine a difference in the surface area of the airfoil connector; in case that a difference is determined, adjusting, by the processor, the 3D surface area plan to provide an adjusted 3D surface area plan; and printing, by a dedicated 3D printer, a layer of graphite onto the airfoil connector according to the adjusted 3D surface area plan.

### FIELD OF THE INVENTION

The present invention relates to airfoil connectors. More particularly, the present invention relates to systems and methods for application of a lubricant such as graphite on an airfoil connector.

### BACKGROUND OF THE INVENTION

An airfoil is a thin metal sheet with a defined and/or precise geometry. During the processing of airfoils, e.g., for manufacturing of jet engines, a plurality of thin metal sheets or blades are connected to a disk.

In order to improve efficiency of the airfoil movement, a lubricant is added between the disk and the plurality of thin metal sheets or blades. For example, the lubricant may be applied by manually spraying the lubricant, e.g., graphite, as a liquid.

The addition of the lubricant is intended to reduce the amount of resistance that occurs due to friction during operation of the jet engine, e.g., friction between the airfoil and the air through which the airfoil passes.

Current solutions to reduce the amount of resistance that occurs due to friction include application of a masking device on at least one airfoil and manual spraying of the lubricant (e.g., graphite) between the disk and the plurality of thin metal sheets or blades.

However, due to the manual process of spraying, the resulting lubricated object has some overspray, i.e., excess sprayed lubricant, that needs to be manually removed by inspecting and cleaning each airfoil individually, since the masking device cannot provide complete protection from the overspray. If not properly cleaned, the overspray may cause damage to the material of the airfoil during operation of the airfoil(s) or may reduce efficiency of the airfoil operation.

It would be desirable to provide a system and method for automatically applying graphite on an airfoil connector, such that overspray is prevented.

### SUMMARY OF THE INVENTION

There is thus provided, in accordance with some embodiments of the invention, a method of applying graphite on an airfoil connector, the method including: receiving, by a processor, a three-dimensional (3D) surface area plan for the airfoil connector; imaging the airfoil connector to determine a 3D scheme of the airfoil connector; comparing, by the processor, the received 3D surface area plan and the determined 3D scheme to determine a difference in the surface area of the airfoil connector; in case that a difference is determined, adjusting, by the processor, the 3D surface area plan to provide an adjusted 3D surface area plan; and printing, by a dedicated 3D printer, a layer of graphite onto the airfoil connector according to the adjusted 3D surface area plan.

In some embodiments, the processor is to apply an image processing algorithm on images received by imaging the airfoil connector. In some embodiments, the processor is to apply a deep learning algorithm to determine the 3D scheme from the imaging of the airfoil connector.

In some embodiments, the airfoil connector moves along the 3D printer in accordance with the adjusted 3D surface area plan.

In some embodiments, an alert is issued when the determined difference is greater than a predetermined threshold.

There is thus provided, in accordance with some embodiments of the invention, a system for applying graphite on an airfoil connector, the system including: an imager to image the airfoil connector to determine a 3D scheme of the airfoil connector; a processor, coupled to the imager and configured to: receive a three-dimensional (3D) surface area plan for the airfoil connector; compare the received 3D surface area plan and the determined 3D scheme to determine a difference in the surface area of the airfoil connector; in case that a difference is determined, adjust the 3D surface area plan to provide an adjusted 3D surface area plan; and a dedicated 3D printer, coupled to the processor and configured to print a layer of graphite onto the airfoil connector according to the adjusted 3D surface area plan.

In some embodiments, the processor is to apply an image processing algorithm on images received by imaging the airfoil connector. In some embodiments, the processor is to apply a deep learning algorithm to determine the 3D scheme from the imaging of the airfoil connector.

In some embodiments, the processor is to give instructions to move the airfoil connector along the 3D printer in accordance with the adjusted 3D surface area plan.

In some embodiments, an alert is issued when the determined difference is greater than a predetermined threshold.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a block diagram of an example computing device, according to some embodiments of the invention;

FIG. 2 shows a system for applying graphite on an airfoil connector, according to some embodiments of the invention;

FIGS. 3A and 3B show an illustration of the difference in the expected surface area of the airfoil connector, according to some embodiments of the invention; and

FIG. 4 shows a flowchart for a method of applying graphite on an airfoil connector, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer’s registers and/or memories into other data similarly represented as physical quantities within the computer’s registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof may occur or be performed simultaneously, at the same point in time, or concurrently.

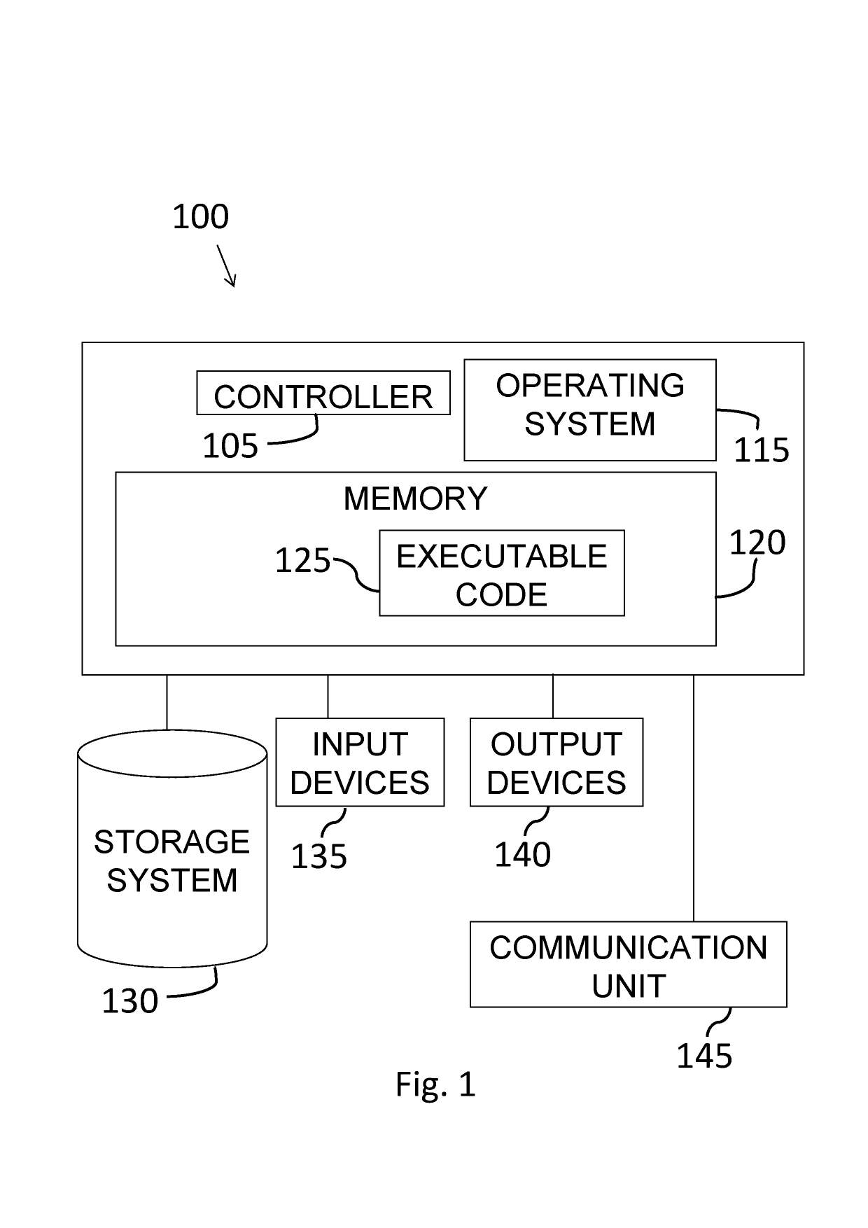

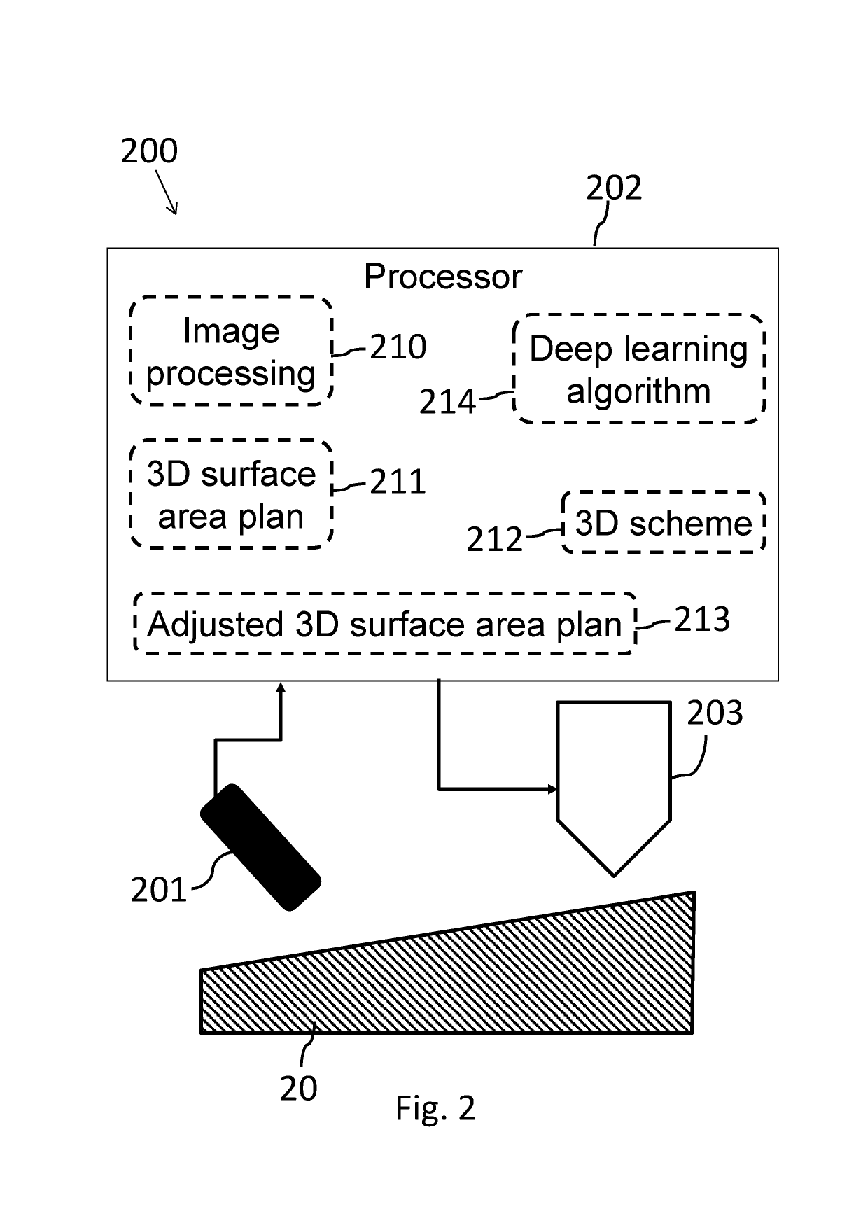

Reference is made to FIG. 1, which is a schematic block diagram of an example computing device, according to some embodiments of the invention. Computing device 100 may include a controller or processor 105 (e.g., a central processing unit processor (CPU), a chip or any suitable computing or computational device), an operating system 115, a memory 120 with executable code 125, storage 130, input devices 135 (e.g. a keyboard or touchscreen), output devices 140 (e.g., a display), and a communication unit 145 (e.g., a cellular transmitter or modem, a Wi-Fi communication unit, or the like) for communicating with remote devices via a communication network, such as, for example, the Internet. Controller 105 may be configured to execute program code to perform operations described herein. Embodiments may include one or more computing device(s) 100, for example, to act as the various devices or the components shown in FIG. 2. For example, components of system 200 may be or may include computing device 100 or components thereof.

Operating system 115 may be or may include any code segment (e.g., one similar to executable code 125 described herein) designed and/or configured to perform tasks involving coordinating, scheduling, arbitrating, supervising, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of similar and/or different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be a software application that performs methods as further described herein. Although, for the sake of clarity, a single item of executable code 125 is shown in FIG. 1, a system according to embodiments of the invention may include a plurality of executable code segments similar to executable code 125 that may be stored into memory 120 and cause controller 105 to carry out methods described herein.

Storage 130 may be or may include, for example, a hard disk drive, a universal serial bus (USB) device or other suitable removable and/or fixed storage unit. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a keyboard, a touch screen or pad, one or more sensors or any other or additional suitable input device. Any suitable number of input devices 135 may be operatively connected to computing device 100. Output devices 140 may include one or more displays or monitors and/or any other suitable output devices.

Any suitable number of output devices 140 may be operatively connected to computing device 100. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105. Such a non-transitory computer readable medium may be for example a memory, a disk drive, or a USB flash memory, encoding, including or storing instructions, e.g., computer-executable instructions, which when executed by a processor or controller, carry out methods disclosed herein.

The storage medium may include, but is not limited to, any type of disk including, semiconductor devices such as read-only memories (ROMs) and/or random-access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to embodiments of the invention may include components such as, but not limited to, a plurality of central processing units (CPUs), a plurality of graphics processing units (GPUs), or any other suitable multi-purpose or specific processors or controllers (e.g., controllers similar to controller 105), a plurality of input units, a plurality of output units, a plurality of memory units, and a plurality of storage units.

An embodiment may additionally include other suitable hardware components and/or software components. Some embodiments may include or may be, for example, a personal computer, a desktop computer, a laptop computer, a workstation, a server computer, a network device, or any other suitable computing device.

For example, a system as described herein may include one or more facility computing device 100 and one or more remote server computers in active communication with one or more facility computing device 100 such as computing device 100, and in active communication with one or more portable or mobile devices such as smartphones, tablets and the like.

Reference is now made to FIG. 2, which shows a system 200 for applying graphite on an airfoil connector 20, according to some embodiments of the invention. The following description refers to application of graphite, while the same may equally be applied to any lubricant or a sprayed material.

The system 200 may include an imager 201 (e.g., a video camera) for imaging the airfoil connector 20. The imager 201 may be connected to a processor 202 (such as controller 105, shown in FIG. 1) such that images from the imager 201 may be provided to the processor 202 for image processing algorithm 210 applied on images received by imaging the airfoil connector 20.

The image processing algorithm 210 may be used to recognize the actual geometry and/or borderlines from the images of the airfoil connector 20.

In some embodiments, the processor 202 may receive a three-dimensional (3D) surface area plan 211 for the airfoil connector 20.

The 3D surface area plan 211 may include a plan for the expected surface area of the airfoil connector 20. The 3D surface area plan 211 may be different for each airfoil connector 20.

For example, the processor 202 may receive the 3D surface area plan 211 from a dedicated server (e.g., via wired or wireless communication) with predefined plans for 3D surface areas of various airfoil connectors.

Once the images of the airfoil connector 20 are received at the processor 202 from the imager 201, a 3D scheme 212 may be determined for the airfoil connector 20. The 3D scheme 212 may include a computed 3D scheme of the airfoil connector 20 based on the received imager data.

For example, the 3D scheme 212 may be determined by the processor 202 using the image processing algorithm 210.

In some embodiments, the processor 202 may compare the received 3D surface area plan 211 and the determined 3D scheme 212 to determine an occurrence of a difference in the surface area of the airfoil connector 20.

In some embodiments, the processor 202 may issue an alert when the determined difference in the surface area is greater than a predetermined threshold, e.g., 1x1 millimeters.

If a difference in the surface area greater than a predetermined threshold is determined, then the 3D surface area plan needs adjustment prior to application of the graphite onto the airfoil connector 20. Thus, in case that a difference in the surface area greater than a predetermined threshold is determined by the processor 202, the processor 202 may adjust the 3D surface area plan 211 to provide an adjusted 3D surface area plan 213.

For example, a difference in surface area size of the airfoil connector 20 between 49 millimeters and 50 millimeters may cause substantial overspray on the airfoil connector 20 if not adjusted by the processor 202. By accurately adjusting the 3D surface area plan of the airfoil connector 20, it may be possible to prevent overspray and provide accurate application of the graphite.

According to some embodiments, the system 200 may include a 3D printer 203 (e.g., such as a dedicated inkjet printer) configured to apply a layer of graphite onto the airfoil connector 20. In some embodiments, the 3D printer 203 may be connected to the processor 202 and may receive commands therefrom.

In some embodiments, the 3D printer 203 may be replaced by a programmable logic controller (PLC) controlled low pressure pump.

Once the adjusted 3D surface area plan 213 is determined by the processor 202, the processor 202 may instruct the 3D printer 203 to apply graphite onto the airfoil connector 20 in accordance with the adjusted 3D surface area plan 213.

In accordance with the instructions form the processor 202, the 3D printer 203 may print a layer of graphite onto the airfoil connector 20 according to the adjusted 3D surface area plan 213 so that the printing is within the adjusted border lines.

According to some embodiments, the processor 202 may apply a deep learning algorithm 214 to determine the 3D scheme from the imaging of the airfoil connector 20. Utilization of a dedicated deep learning algorithm 214, for instance trained on a large dataset of shape/size of airfoil connectors, may provide more accurate results for the application of the graphite layer. For example, accuracy of 0.2 millimeters may be achieved.

According to some embodiments, the airfoil connector 20 may be moved (e.g., by an industrial robotic arm) relative to the 3D printer 203 in accordance with the adjusted 3D surface area plan 213. Alternatively, the 3D printer 203 may be moved relative to the airfoil connector 20 to apply the graphite layer.

In some embodiments, the airfoil connector 20 may be heated prior to application of the graphite layer in order to allow faster drying of the graphite layer, and accordingly reduce time of the preparation process.

Overall, such a system may reduce substantial time of a manual worker that needs to clean overspray of each airfoil connector individually.

Thus, an improvement in process consistency, thickness and location repeatability may be achieved since there is no longer manual intervention. Additionally, such a process no longer requires usage of dedicated masking devices.

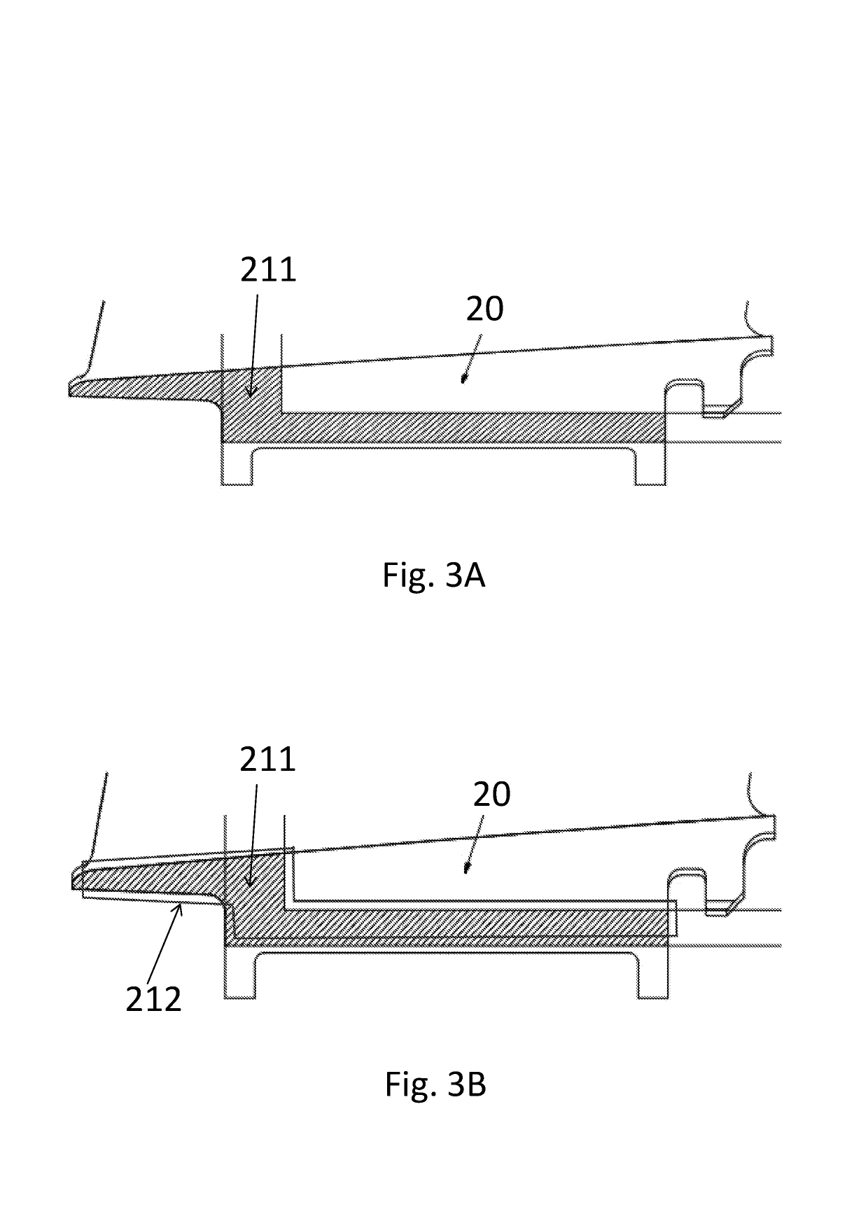

Reference is now made to FIGS. 3A and 3B, which show an illustration of the difference in the expected surface area of the airfoil connector, according to some embodiments of the invention.

FIG. 3A shows the airfoil connector 20 with an indication of the received 3D surface area plan 211. The processor 202 (shown in FIG. 2) may apply the received 3D surface area plan 211 onto the images of the airfoil connector 20 received from the imager 201 (shown in FIG. 2) and, when needed, may use image processing to check for differences in the surface area.

FIG. 3B shows the airfoil connector 20 with the indication of the received 3D surface area plan 211 and the 3D scheme 212 from the imager as well. The processor 202 may apply the received 3D surface area plan 211 and the 3D scheme 212 onto the images of the airfoil connector 20 received from the imager 201 to determine differences in the surface area. Once the difference is determined, the application of graphite onto the airfoil connector 20 is correctly carried out so that the required amount of graphite may be precisely applied.

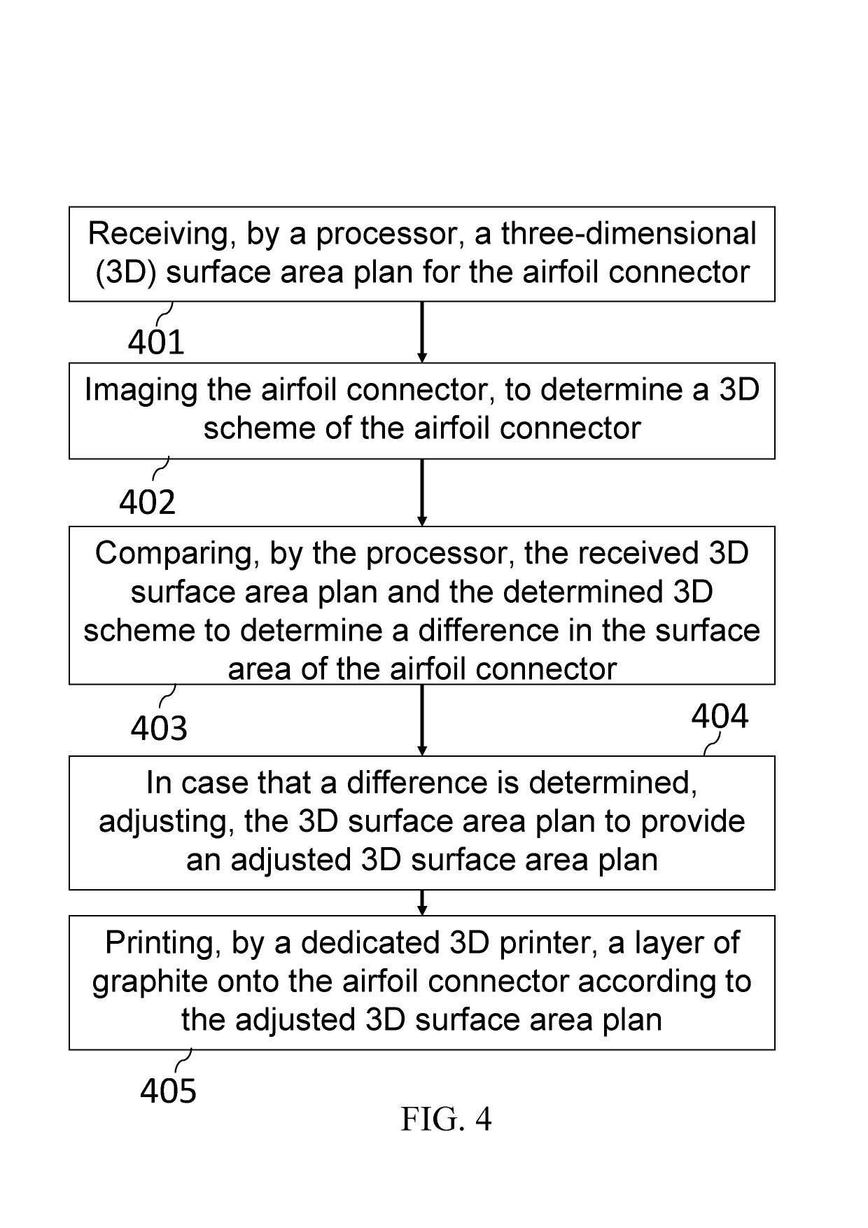

Reference is made to FIG. 4, which shows a flowchart for a method of preparing a metal object for machining, according to some embodiments of the invention.

The processor may receive 401 a three-dimensional (3D) surface area plan for the airfoil connector.

The imager may image 402 the airfoil connector, to determine a 3D scheme of the airfoil connector.

The processor may compare 403 the received 3D surface area plan and the determined 3D scheme to determine a difference in the surface area of the airfoil connector.

The processor may adjust 404 the 3D surface area plan to provide an adjusted 3D surface area plan in case that a difference is determined.

The 3D printer may accordingly print 405 a layer of graphite onto the airfoil connector according to the adjusted 3D surface area plan.

While certain features of the invention have been illustrated and described herein, many modifications, substitutions, changes, and equivalents may occur to those skilled in the art. It is, therefore, to be understood that the appended claims are intended to cover all such modifications and changes.

Various embodiments have been presented. Each of these embodiments may of course include features from other embodiments presented, and embodiments not specifically described may include various features described herein.

1. A method of applying graphite on an airfoil connector, the method comprising:
receiving, by a processor, a three-dimensional (3D) surface area plan for the airfoil connector;
imaging the airfoil connector to determine a 3D scheme of the airfoil connector;
comparing, by the processor, the received 3D surface area plan and the determined 3D scheme to determine a difference in the surface area of the airfoil connector;
in case that a difference is determined, adjusting, by the processor, the 3D surface area plan to provide an adjusted 3D surface area plan; and
printing, by a dedicated 3D printer, a layer of graphite onto the airfoil connector according to the adjusted 3D surface area plan.

2. The method of claim 1, further comprising applying, by the processor, an image processing algorithm on images received by imaging the airfoil connector.

3. The method of claim 2, further comprising applying, by the processor, a deep learning algorithm to determine the 3D scheme from the imaging of the airfoil connector.

4. The method of claim 1, further comprising moving the airfoil connector along the 3D printer in accordance with the adjusted 3D surface area plan.

5. The method of claim 1, further comprising issuing an alert when the determined difference is greater than a predetermined threshold.

6. A system for applying graphite on an airfoil connector, the system comprising:
an imager to image the airfoil connector to determine a 3D scheme of the airfoil connector;
a processor, coupled to the imager and configured to:
receive a three-dimensional (3D) surface area plan for the airfoil connector;
compare the received 3D surface area plan and the determined 3D scheme to determine a difference in the surface area of the airfoil connector;
in case that a difference is determined, adjust the 3D surface area plan to provide an adjusted 3D surface area plan; and
a dedicated 3D printer, coupled to the processor and configured to print a layer of graphite onto the airfoil connector according to the adjusted 3D surface area plan.

7. The system of claim 6, wherein the processor is to apply an image processing algorithm on images received by imaging the airfoil connector.

8. The system of claim 7, wherein the processor is to apply a deep learning algorithm to determine the 3D scheme from the imaging of the airfoil connector.

9. The system of claim 6, wherein the processor is to give instructions to move the airfoil connector along the 3D printer in accordance with the adjusted 3D surface area plan.

10. The system of claim 6, wherein the processor is to issue an alert when the determined difference is greater than a predetermined threshold.
